(19) United States
(12) Patent Application Publication
(10) Pub. No.: US 2010/0170271 A1
(43) Pub. Date: Jul. 8, 2010

(54) REFRIGERANT SYSTEM

(75) Inventors: Alexander Lifson, Manlius, NY (US); Michael F. Taras, Fayettevilee, NY (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CARRIER CORPORATION, Farmington, CT (US)

(21) Appl. No.: 12/663,603

(22) PCT Filed: Jun. 8, 2007
(86) PCT No.: PCT/US07/13617

§ 371 Date: Dec. 8, 2009

(51) Int. Cl. F25B 43/00; F25B 1/00; F25B 41/00; G05D 7/00

(52) U.S. Cl. 62/84; 62/498; 62/513; 62/468; 700/282

(57) ABSTRACT

The present disclosure provides a method of operation of a refrigerant system, which comprises a main refrigerant circuit, a reheat circuit, and a flow control device, which has a first position isolating said reheat circuit from said main refrigerant circuit, and a second position placing said reheat circuit in fluid communication with said main refrigerant circuit. The refrigerant system further comprises a controller in electrical communication with said flow control device. The controller is configured to move the flow control device to the first position during a cooling mode, and to move the flow control device to the second position during a reheating mode or an oil recovery mode. The refrigerant system controller can execute an oil recovery mode in continuous or intermittent manner.

### BACKGROUND OF THE DISCLOSURE

1. Field of the Disclosure

This disclosure relates to refrigeration and air conditioning systems. More particularly, this disclosure relates to refrigerant systems having a reheat circuit with an improved oil return mechanism.

2. Description of the Related Art

Refrigerant systems are utilized to control the temperature and humidity of air in various environments to be conditioned. Typically, a refrigerant is compressed in a compressor and delivered to a heat rejection heat exchanger. Although, as known, the heat rejection heat exchanger is a condenser for subcritical applications and a gas cooler for transcritical applications, for simplicity, it will be referred to as a condenser throughout the disclosure. In the condenser, heat is exchanged between outside ambient air and the refrigerant, cooling the refrigerant. From the condenser, the refrigerant passes to an expansion device, in which the refrigerant is expanded to a lower pressure and temperature, and is then passed through an evaporator. In the evaporator, heat is exchanged between the refrigerant and the indoor air, to condition the indoor air. When the refrigerant system is in operation, the evaporator cools the air that is being supplied to the indoor environment. In addition, as the temperature of the indoor air is lowered, moisture usually is also taken out of the air. In this manner, the humidity level of the indoor air can also be controlled.

In some cases, the temperature level to which the air is brought to provide comfort environment in the conditioned space, may need to be higher than the temperature that would provide the ideal humidity level. Such corresponding levels of temperature and humidity may vary from one application to another and are highly dependent on environmental and operating conditions. This has presented design challenges to refrigerant system designers. One way to address such challenges is to utilize reheat circuits comprising reheat heat exchangers. In many cases, the reheat heat exchangers are placed in the path of the indoor air stream, behind the evaporator. The reheat heat exchangers are employed for the purpose of reheating the air supplied to the conditioned space after it has been overcooled by contact with the external surfaces of the evaporator.

One option available to a refrigerant system designer is to integrate the reheat circuit into the main refrigerant circuit. The reheat circuit can comprise one or more reheat heat exchangers. When using a reheat circuit, at least a portion of the refrigerant upstream of the expansion device is diverted from the main refrigerant circuit, passed through a reheat heat exchanger, and is then returned back to the main refrigerant circuit. At least a portion of the conditioned air, having passed over the evaporator, is then passed over this reheat heat exchanger to be reheated to a desired temperature. When there is no need to reheat the conditioned air, the reheat circuit is isolated from the main refrigerant circuit.

There are many variations of the reheat circuit schematics that are known in the art. One drawback of all these designs, however, is that over time the refrigerant, carrying the compressor oil, will migrate to the coldest spot within the refrigerant circuit, i.e. the reheat heat exchanger. This migrated refrigerant and compressor oil will be trapped within the reheat circuit when the reheat circuit is not activated, i.e. when the refrigerant system is performing a cooling operation without any reheating of the conditioned air required. This can occur for prolonged time intervals, during which time a substantial amount of compressor oil can accumulate in the reheat circuit, which is a serious problem. The loss of oil in the compressor sump can cause catastrophic compressor failure.

Accordingly, there is a need for a reheat refrigerant system that will eliminate this and other disadvantages of currently available systems.

### SUMMARY OF THE INVENTION

The present disclosure provides a refrigerant system, which comprises a main refrigerant circuit, a reheat circuit, and a flow control device (such as a three-way valve) that can selectively route at least a portion of refrigerant through the reheat circuit. This flow control device has a first position isolating said reheat circuit from said main refrigerant circuit, and a second position placing said reheat circuit in fluid communication with said main refrigerant circuit. The refrigerant system further comprises a controller in electrical communication with said flow control device. The controller is configured to selectively move the flow control device to the first position during a cooling mode, and to move the flow control device to the second position during a reheat mode or an oil recovery mode

The present disclosure also provides a method of recovering oil in a refrigerant system. The refrigerant system comprises a main refrigerant circuit, a reheat circuit, a flow control device, and a controller in electrical communication with said flow control device. The flow control device has a first position isolating the reheat circuit from the main refrigerant circuit, and a second position placing the reheat circuit in fluid communication with the main refrigerant circuit. The method comprises the steps of moving the flow control device to the first position during a cooling mode of operation, and moving the flow control device to the second position during a reheat mode or an oil recovery mode of operation.

### BRIEF DESCRIPTION OF THE DRAWINGS

FIG. 1 shows a schematic drawing of the refrigerant system of the present disclosure; and

FIG. 2 shows a schematic drawing of an alternative embodiment of the refrigerant system of the present disclosure.

### DETAILED DESCRIPTION OF THE DISCLOSURE

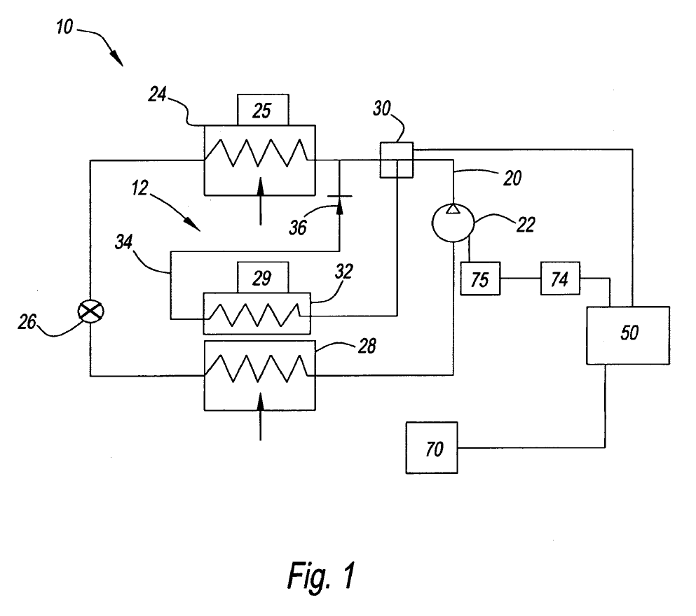

Referring to FIG. 1, a refrigerant system 10 of the present disclosure is shown. Refrigerant system 10 advantageously comprises a controller 50 that can selectively and periodically remove excess refrigerant and compressor oil from a reheat circuit 12, in the manner discussed below. Thus, refrigerant system 10 substantially eliminates the problems associated with a low oil level in a compressor sump that may lead to unrecoverable compressor failure.

Refrigerant system 10 has compressor 22, condenser 24, expansion device 26, and evaporator 28, which are all in serial fluid communication with each other through refrigerant lines 20. A refrigerant (not shown) is compressed by compressor 22, moves through refrigerant line 20, and passes through condenser 24, where it is cooled by interaction with outside ambient air. Condenser fan 25 can blow ambient air over condenser 24, to assist with the cooling of the refrigerant. The refrigerant then passes through refrigerant line 20 to expansion device 26, and then to evaporator 28. Evaporator fan 29 blows air, which is cooled and dehumidified by its contact with the external surfaces of evaporator 28, into the environment to be conditioned.

Refrigerant system 10 can also have a reheat circuit 12, to be used in the case when the demand for dehumidification is different than the demand for cooling. Reheat circuit 12 is in communication with refrigerant line 20 at a point between compressor 22 and condenser 24. Reheat circuit 12 comprises a flow control device 30, reheat heat exchanger 32, reheat circuit refrigerant line 34, and check valve 36, all in serial fluid communication with each other. In one embodiment, flow control device 30 can be a three-way valve. Thus, during reheat operation, at least a portion of the refrigerant passing through refrigerant line 20 is diverted into reheat circuit 12 by flow control device 30. The refrigerant, which at this point is still at a high pressure and temperature, then passes through reheat heat exchanger 32. The air being blown by evaporator fan 29 into the environment to be conditioned, as discussed above, is also passed over reheat heat exchanger 32. Thus, this air has been dehumidified, but has been reheated by contact with the external surfaces of reheat heat exchanger 32. The refrigerant then leaves reheat heat exchanger 32, and passes through check valve 36, which prevents floodback of refrigerant into reheat circuit 12. The refrigerant in reheat circuit 12 is then sent back through the main refrigerant circuit.

Controller 50, which is in communication with flow control device 30, can control flow control device 30 to divert at least a portion of refrigerant through reheat circuit 12 as desired. When reheating of the conditioned air is not needed, refrigerant system 10 can operate in a cooling mode, and controller 50 controls flow control device 30 so that it is in a first position, which isolates reheat circuit 12 from the main refrigerant circuit. When reheating of the conditioned air is desired, refrigerant system 10 can be in a reheat mode. In this reheat mode, controller 50 can control flow control device 30 so that it is in a second position, and at least a portion of the refrigerant passing through refrigerant lines 20 is diverted through reheat circuit 12. This second position of flow control device 30 can be such that either all of the refrigerant is diverted through reheat circuit 12, or only a portion thereof. Controller 50 may control flow control device 30 in either a modulated or pulsed manner. That is, controller 50 may change the hydraulic resistance of the refrigerant flow path through flow control device 30 continuously, or may abruptly pulse between fully closed and fully open positions, to allow for continuous or intermittent refrigerant flow through reheat circuit 12.

As previously discussed, the reheat circuits of the prior art have been known to exhibit significant drawbacks when they are inactive. Compressor oil can be dissolved within the refrigerant, and carried by the refrigerant throughout refrigerant system 10. When reheat circuit 12 is not engaged, i.e. when flow control device 30 is not diverting any refrigerant into reheat circuit 12, some amount of oil will be trapped with the refrigerant within reheat circuit 12. Reheat heat exchanger 32 is positioned downstream of evaporator 28 and exchanges heat with cold air exiting evaporator 28, regardless of whether reheat circuit 12 is active. Therefore, reheat heat exchanger 32 always represents one of the coldest spots within refrigerant system 10. As a result, refrigerant, as well as oil dissolved in that refrigerant, will migrate to reheat heat exchanger 32, until overall refrigerant charge within refrigerant system 10 reaches equilibrium conditions.

in some applications, reheat circuit 12 will be inactive for extended periods of time, allowing significant amounts of compressor oil to be accumulated therein. More oil accumulates in reheat circuit 12, less oil is circulated throughout main refrigerant circuit 10, and the oil level in compressor sump 75 drops. Additionally, the more oil that is accumulated in reheat circuit 12, the more difficult it will be to bring it back to the compressor. The compressor oil is critical to the operation of compressor 22, since it lubricates moving compressor components such as bearings and compression elements, as well as seals gaps between compression elements. This latter effect prevents refrigerant bypass, or internal refrigerant leakage within the compressor from a high side to a low side, which is detrimental to compressor performance. If too much oil is accumulated within reheat circuit 12, compressor 22 will starve of oil and will be at risk of failure. Compressor manufacturers will often supply their compressors with a certain fixed amount of oil that is needed for successful operation. While manufacturers may account for a certain amount of oil to be carried by the refrigerant throughout the refrigerant system 10, they normally do not account for additional potential oil traps such as reheat circuit 12. Thus, it is essential to minimize the amount of compressor oil that is accumulated within reheat circuit 12.

The present disclosure has thus developed a novel approach for alleviating the risk of compressor failure, while reheat circuit 12 is inactive. Controller 50 can be configured so that it periodically opens flow control device 30 for a relatively short period of time, entering an oil recovery mode. This allows compressor oil that was leaked into reheat circuit 12 to be returned to the main refrigerant circuit of refrigerant system 10, and thus to sump 75 of compressor 22. When reheat circuit 12 is opened, the refrigerant that passes therethrough carries the accumulated compressor oil back into the main refrigerant circuit of refrigerant unit 10, and back to sump 75 of compressor 22.

In a first embodiment, the periodic opening of flow control device 30 can be done at regular time intervals that are pre-programmed into controller 50. In a second embodiment, there can be an input device 70, such as an optical or motion sensor, that is in communication with controller 50 and disposed within the environment to be conditioned. Input device 70 can detect when there is no occupant within that environment. The input device 70 can then send a signal to controller 50 to open flow control device 30, if reheat circuit 12 has been inactive for a longer than desired period of time. Input device 70 can be employed if it is not desirable to enter oil recovery mode when there is an occupant within the environment to be conditioned. It should be understood that there are many types of occupancy sensors, all of which are within the scope of the invention.

In a third embodiment, controller 50 can be in communication with a second input device 74 that is in communication with sump 75 of compressor 22. Second input device 74 detects the amount of oil disposed within sump 75, which is an indication of the amount of oil that has been accumulated in the oil “traps” throughout refrigerant system 10, and most likely within reheat circuit 12. If the amount of oil within sump 75 drops below a desired level, second input device 74 can send a signal to controller 50 to enter oil recovery mode. Second input device 74 can be, for example, a level, optical, capacitive, inductive, or resistive sensor, or any other sensor suitable for detecting the amount of oil in sump 75. Second input device 74 can also be disposed at other locations within refrigerant system 10, where it would be able to measure the remaining amount of compressor oil or amount of oil accumulated within reheat circuit 12.

Controller 50 can also use a combination of one or more of any of the above devices to enter an oil recovery mode. Controller 50 can also be set to enter oil recovery mode at any point that is desirable for safe and reliable operation of refrigerant system 10. Oil recovery mode can occur while refrigerant system 10 is in a cooling mode, or can also occur only when refrigerant system 10 is not in a cooling mode.

During oil recovery mode, controller 50 can open flow control device 30 for a set period of time. In one embodiment, this set period of time can be from about thirty (30) seconds to about three (3) minutes. In one embodiment, the set period of time can be about one (1) minute. Controller 50 can also open flow control device 30 for a series of short, intermittent periods of time to facilitate oil recovery. These intermittent periods of time can be from about two (2) to about ten (10) seconds. They can last for up to about one (1) minute, or be repeated from two (2) to six (6) times.

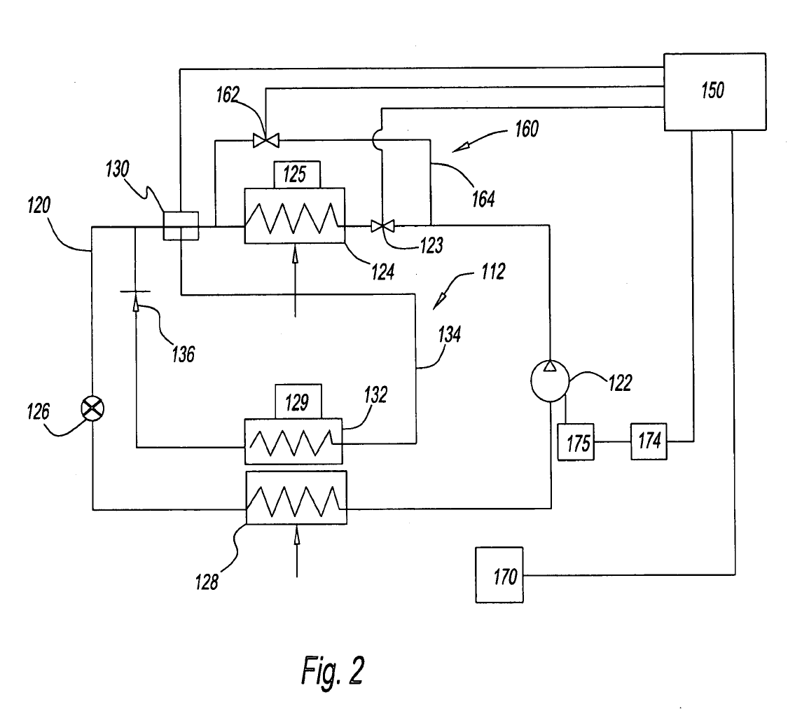

Referring to FIG. 2, a second embodiment of the refrigerant circuit of the present disclosure is shown. Refrigerant system 110 has compressor 122, condenser 124, condenser fan 125, expansion device 126, evaporator 128, evaporator fan 129, and refrigerant lines 120, which all function in an analogous manner to their similarly numbered counterparts of refrigerant system 10. These components are connected in serial fluid communication and in general comprise the main refrigerant circuit.

Refrigerant system 110 also has reheat circuit 112, which comprises flow control device 130, reheat heat exchanger 132, reheat refrigerant lines 134, and check valve 136, which are analogous to their similarly numbered counterparts of reheat circuit 12 of refrigerant system 10. Flow control device 130, however, is disposed at a point in the main refrigerant circuit that is between condenser 124 and expansion device 126. Refrigerant that is diverted through reheat circuit 112 passes through reheat refrigerant line 134, through reheat heat exchanger 132, through check valve 136, and is reintroduced into the main refrigerant circuit at a point between flow control device 130 and expansion device 126.

Refrigerant system 110 also has condenser bypass branch 160. Condenser bypass branch 160 has bypass line 164 and a second flow control device 162, which controls the flow of refrigerant through bypass line 164 in the manner discussed below. Bypass line 164 is in communication with the main refrigerant circuit at two points, one between compressor 122 and condenser 124, and the other between condenser 124 and flow control device 130. Refrigerant system 110 also optionally has a third flow control device 123, which is disposed within the main refrigerant circuit, and controls the flow of refrigerant through condenser 124. Second flow control device 162 and third control device 123 can be valves that are of an on/off type, or can be adjustable and operated by controller 150 in a modulated or pulsed manner, as described above. When third flow control device 123 is completely open and second flow control device 162 is completely closed, all of the refrigerant in the main circuit passes through condenser 124. Conversely, when third flow control device 123 is completely closed and second control device 162 is completely open, all of the refrigerant in the main circuit is diverted through bypass line 164, bypassing condenser 124. Controller 150 can also operate flow control devices 162 and 123 such that only a portion of refrigerant bypasses condenser 124 via bypass line 164. Controller 150 is in communication with flow control devices 123, 130, and 162, and can control each of these components to divert refrigerant to the desired locations in the desired proportional amounts.

Thus, reheat circuit 112, in combination with the condenser bypass branch 160, provides control and flexibility in management of the conditioned space humidity and temperature. For example, if reduced cooling is desired in the conditioned space, at least a portion of the refrigerant, or the entire refrigerant flow (in the case of heating), can bypass condenser 124. In this way, the refrigerant reaching reheat heat exchanger 132 provides greater reheat capacity to the air supplied to the conditioned space, since at least some refrigerant amount has not first passed through condenser 124. That is, if at least some refrigerant flow is directed through the bypass line 164, the reheat circuit 112 operates in a mode suitable for applications where dehumidification and no (or very little) cooling or heating is needed. Refrigerant system 110 can also have sensor 170, and compressor 122 have sump 175, and sensor 174, which function in an analogous manner to their similarly numbered counterparts of refrigerant system 10. Refrigerant system 110 is susceptible to the similar problems of refrigerant system 10 and can be operated in one of the oil recovery modes described above, when required.

As known, there are many reheat circuit schematics that are within the scope and can equally benefit from the invention. Also, a three-way valve may be substituted by other flow control devices such as, for instance, a pair of conventional 2-way valves. All these configurations are within the scope of the invention.

It should also be understood that in the context of the above embodiments, a compressor can be selected from a variety of compressor types, including reciprocating, screw and scroll axial compressors. Each compressor can be represented by multiple compressors. For example, a compressor may consist of several sequential compressor stages or/and multiple compressors operating in parallel or so-called tandem arrangement. Further, this invention can be applied to different refrigerant system types, as for example including residential and commercial cooling and heat pump applications, which have provisions for dehumidification reheat operation.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A refrigerant system comprising:
a main refrigerant circuit;
a reheat circuit;
a flow control device having a first position isolating said reheat circuit from said main refrigerant circuit, and a second position placing said reheat circuit in fluid communication with said main refrigerant circuit; and
a controller in electrical communication with said flow control device, said controller being configured to move said flow control device to said first position during a cooling mode of operation, and to move said flow control device to said second position during a reheat mode or an oil recovery mode of operation.

2. The refrigerant system of claim 1, wherein said flow control device comprises a three-way valve, or a pair of conventional two-way valves.

3. The refrigerant system of claim 1, wherein said flow control device is an adjustable flow control device.

4. The refrigerant system of claim 3, wherein said controller moves said adjustable flow control device with modulation control, pulsation control, or both.

5. The refrigerant system of claim 1, wherein said controller is configured to move said flow control device to said second position during said oil recovery mode at selected time intervals.

6. The refrigerant system of claim 1, wherein said controller is configured to move said flow control device to said first position during said oil recovery mode based on input from a sensor.

7. The refrigerant system of claim 6, wherein said sensor measures an oil content in said main refrigerant circuit, said reheat circuit, or both.

8. The refrigerant system of claim 6, wherein said sensor measures an oil level in a sump, wherein said sump is in fluid communication with a compressor.

9. The refrigerant system of claim 6, wherein said sensor is configured to measure movement in a space conditioned by the refrigerant system.

10. The refrigerant system of claim 1, wherein said controller moves said flow control device to said second position for a period of about thirty seconds to about three minutes, during said oil recovery mode.

11. The refrigerant system of claim 10, wherein said controller moves said flow control device to said second position for a period of about one minute, during said oil recovery mode.

12. The refrigerant system of claim 1, wherein said controller moves said flow control device to said second position for a period of time about two to about ten seconds, and moves said flow control device back to said first position after said period of time, during said oil recovery mode.

13. The refrigerant system of claim 12, wherein said controller repeats said moving of said flow control device to said second position for said period of time, and moving said flow control device back to said first position, for a total period of time of about 1 minute.

14. The refrigerant system of claim 12, wherein said controller repeats said moving of said flow control device to said second position for said period of time, and moving said flow control device back to said first position, for two to six times.

15. The refrigerant system of claim 1, wherein:
said main refrigerant circuit comprises a heat rejection heat exchanger, and
said reheat circuit comprises a reheat heat exchanger,
wherein said heat rejection heat exchanger is positioned upstream of said reheat heat exchanger, with respect to the flow of a refrigerant passing through said main refrigerant circuit.

16. The refrigerant system of claim 1, wherein:
said main refrigerant circuit comprises a heat rejection heat exchanger, and
said reheat circuit comprises a reheat heat exchanger,
wherein said heat rejection heat exchanger is positioned downstream of said reheat heat exchanger, with respect to the flow of a refrigerant passing through said main refrigerant circuit.

17. The refrigerant system of claim 16, further comprising a second flow control device, wherein said controller controls said second flow control device, so that at least a portion of a refrigerant passing through said main refrigerant circuit bypasses said heat rejection heat exchanger.

18. The refrigerant system of claim 17, wherein said second flow control device is an adjustable flow control device.

19. The refrigerant system of claim 18, wherein said controller moves said adjustable flow control device with modulation control, pulsation control, or both.

20. A method of recovering oil in a refrigeration system, comprising:
controlling a refrigerant to flow through a main refrigeration circuit but not a reheat circuit during a cooling mode of operation;
controlling said refrigerant to flow through said main refrigeration circuit and said reheat circuit during a reheat mode of operation; and
controlling said refrigerant to flow through said main refrigeration circuit and said reheat circuit during an oil recovery mode of operation.

21. The method of claim 20, wherein said refrigerant is controlled to flow through said main refrigeration circuit and said reheat circuit during an oil recovery mode of operation at selected time intervals.

22. The method claim 20, wherein refrigerant is controlled to flow through said main refrigeration circuit and said reheat circuit during an oil recovery mode of operation, based on input from an input device.

23. The method of claim 22, wherein said input device measures an oil content in said main refrigerant circuit, said reheat circuit, or both.

24. The method of claim 22, wherein said input device measures an oil level in a sump, wherein said sump is in fluid communication with a compressor.

25. The method of claim 22, wherein said input device is configured to measure movement in a space conditioned by the refrigerant system.
